(19) United States
(12) Patent Application Publication
(10) Pub. No.: US 2026/0049804 A1
(43) Pub. Date: Feb. 19, 2026

(54) Tape measure with flexure for lock linkage

(71) Applicant: Reekon Tools Inc., Boston, MA (US)

(72) Inventors: Konstantinos Oikonomopoulos, Boston, MA (US); Edgar Sutawika, Cambridge, MA (US)

(21) Appl. No.: 18/808,197

(22) Filed: Aug. 19, 2024

(51) Int. Cl. G01B 3/1007; G01B 3/1005

(52) U.S. Cl. CPC G01B 3/1007; G01B 2003/1015; G01B 2003/1038

(57) ABSTRACT

A tape measure device comprising a housing at includes a reel that support a tape measure, a linkage travel pathway, and an external locking mechanism configured to be engaged by a user to lock the tape measure at some extended position. According to this disclosure, a lock linkage flexure that transmits translational force but without requiring a straight line path to do so is supporting in the linkage travel pathway. In one embodiment, the flexure is implemented as a metal linkage that is constrained in the curved travel pathway and maintains a low profile as it is actuated by the lock action (whether in an auto-lock configuration or fixed lock format). The metal linkage travels through the define pathway to guide and direct the motion.

### BACKGROUND OF THE INVENTION

This disclosure relates generally to measuring devices and methods.

It is known in the prior art to augment a conventional tape measure device with measuring and processing components that enable greater accuracy to the measurements made by the device. One such example is described and depicted in U.S. Pat. No. 11,460,284, the disclosure of which is hereby incorporated by reference. In a representative embodiment, the device has a housing that supports a display on which measurements are rendered. To take a measurement, a tape measure is extended from the housing at a given distance of interest. The tape measure includes unit length markings. The device housing supports a positional encoder, a processor, and memory/storage that supports control software executed by the processor to control the device. In particular, the control software is configured to process positional information received from the positional encoder, compute a linear location of the measuring tape (its degree of extension from the housing, as measured by the unit length markings), and to generate one or more control signals to drive the display to render positional data

Whether they are conventional mechanical devices or processor-supported digital devices such as described above, it is well-known to include a locking mechanism (with an external button or trigger that is actuated by the user) that is used to hold an extended tape measure at a specific location. While a wide variety of mechanisms can be used for this task, the particular form factor of a device often imposes constraints on the type and size of these mechanisms. Indeed, when it is desired to reduce or optimize form-factor utilization in these devices, the location where the user actuates the button that triggers the holding action is often out of a direct line of effect with respect to the mechanism that needs to be actuated. Prior art solutions to this problem redirect the actuation as needed and, traditionally, this redirection has been achieved through the use of rigid linkages and/or push-rods.

### SUMMARY OF THE INVENTION

This disclosure provides for a tape measure device comprising a housing that includes a reel that support a tape measure, a linkage travel pathway, and an external locking mechanism configured to be engaged by a user to lock the tape measure at some extended position. According to this disclosure, a lock linkage flexure that transmits translational force but without requiring a straight line path to do so is supporting in the linkage travel pathway. In one embodiment, the flexure is implemented as a metal linkage that is constrained in the travel pathway and maintains a low profile as it is actuated by the lock action (whether in an auto-lock configuration or fixed lock format). The metal linkage travels through the define pathway to guide and direct the motion. A secondary spring may be used to restore state when the user release the locking mechanism.

Preferably, the lock linkage flexure is user removable and replaceable, and other materials (such as plastic) may be used.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a tape measure housing that has been opened to show various internal structures including a flexure for lock linkage according to this disclosure;

FIGS. 2A and 2B show movement of the flexure in response to actuation of a lock button; and

FIG. 3 depicts the structural details of the travel pathway within the housing for supporting the flexure;

FIG. 4 depicts the flexure mounted on and carried by and along the travel pathway shown in FIG. 3; and

FIGS. 5A-5C depict a variant embodiment wherein the locking mechanism includes a spring.

### DETAILED DESCRIPTION OF THE INVENTION

As noted above, the subject matter of this disclosure is a flexure for lock linkage in a tape measure device, such as a digital tape measure. The techniques herein are not limited to digital tape measures but may also be applied to conventional mechanical devices.

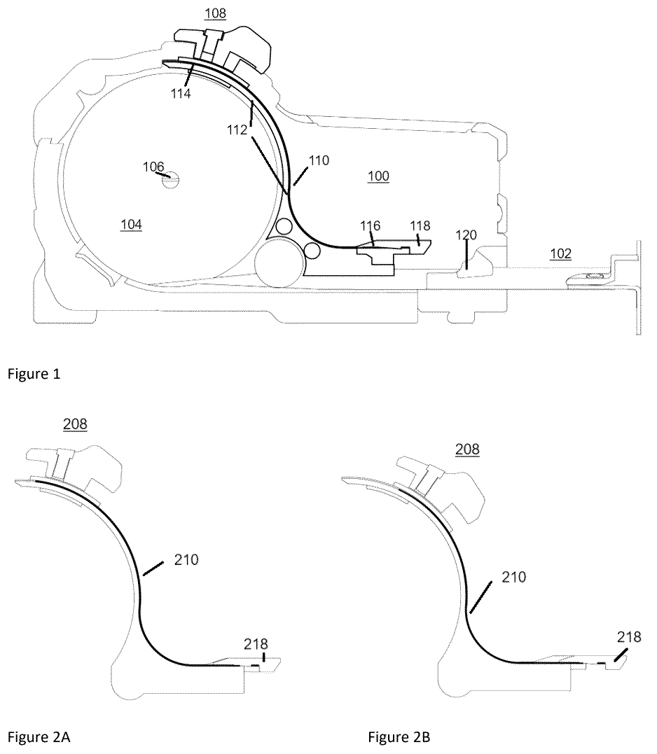

FIG. 1 depicts a tape measure device housing 100 that has been opened up for viewing of relevant internal structural details. Except as necessary to support the flexure of this disclosure, the particular internal details may vary. As depicted, the housing 100 supports a cartridge assembly that comprises a tape measure (tape) 102 that is wound about a reel 104. The reel has an arbor (a central hub) 106 that is inside the unit and that supports a spring (not shown). When extended from the housing, the tape measure may be locked into an extended position by a locking mechanism that includes a lock button 108. As also seen in FIG. 1, a flexure 110 of this disclosure is configured within the housing 100 and is movable along a curved travel pathway or channel 112 that follows the curvature of the reel 104. One end 114 of the flexure is attached to the lock button 108, and the other end 116 carries an endpiece 118 configured to be engaged and retained by a lock member 120 positioned near an outlet of the housing where the tape measure exists. As depicted, in this embodiment the lock member 120 is triangular in shape (when viewed from the side) and includes a structure that is configured to be captured by an underlying edge of the endpiece 118 when the flexure is actuated and thereby positions the endpiece 118 over the lock member 120.

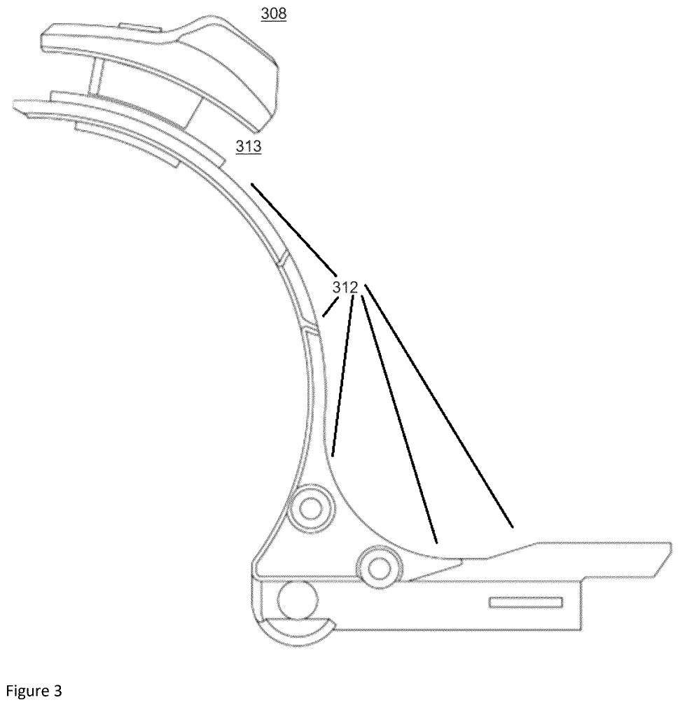

As seen in FIGS. 2A and 2B, the movement of the flexure 210 is carried out by the user (or otherwise by an automated mechanism within the device in response to depression of a control button/switch for example) when the lock button 208 is moved from the position shown in FIG. 2A, to the position shown in FIG. 2B. When the endpiece 218 of the flexure engages the lock member (not shown in this view), the lock member is depressed against the tape measure 102, thereby locking the tape measure at some extended position/location relative to the outlet slot of the housing. The extended position/location represents a desired measurement location that may then be determined and displayed on the device.

FIG. 3 is a side view showing the curved travel pathway 312 that supports the flexure (now shown). This figure also depicts the lock button 308 that is movable along an upper portion 313 of the pathway 313. Typically, this movement occurs in response to a force applied to the lock button 208 by a user; an alternative arrangement uses an electronic control system (not shown) to actuate the lock button 308 indirectly. The particular manner by which the lock button is engaged is not a limitation herein.

Prior to being installed in the device, the flexure for lock linkage typically has a flat or substantially flat structure. The flexure is slide-into an opening in the housing and pushed through the curved travel pathway. As the flexure moves upward and around the rounded configuration of the reel, it eventually meets and is captured by the locking mechanism. To this end, the flexure includes one or more mating holes (at the end 114 as depicted in FIG. 1) that are received by one or more corresponding tabs or projections along the bottom of the locking mechanism. Once captured, the flexure is then secured to the locking button and controlled thereby.

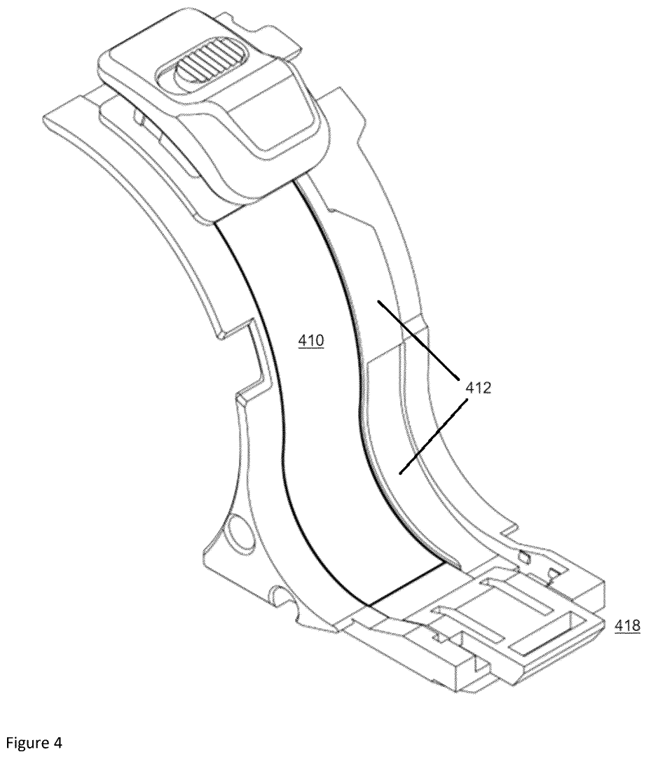

FIG. 4 depicts the flexure 410 laying within the curved travel pathway 412, and wherein the of the flexure has already been captured by the locking button. The operation depicted in FIG. 2B (i.e., movement of the lock button from its initial (unlocked) position to its end (locked) position)) is then used to cause the flexure to move along the pathway until its endpiece 418 is captured by the locking member of the housing. Moving the lock button back to its original position (as shown in FIG. 2A) then draws the flexure back up and once again along its pathway 412. Once the flexure is retained to its initial (unlocked) position, the tape measure is returned into the housing, typically automatically via the charge on the reel spring.

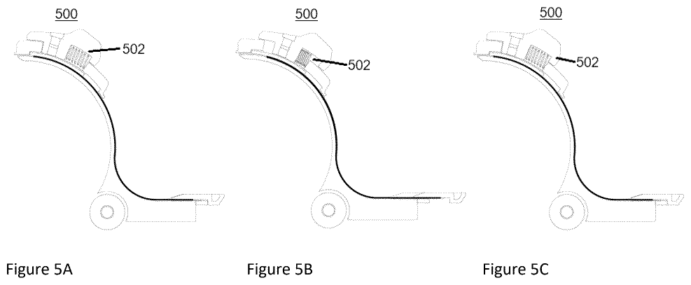

In a variant embodiment, a spring within the lock may be used to facilitate return of the flexure following the movement of the lock button to its initial position. This embodiment is depicted in FIGS. 5A-5C. In particular, FIG. 5A depicts the locking mechanism 500 in its initial position (with the lock un-engaged). In this initial position, spring 502 is not compressed. In FIG. 5B, it is assumed that the tape measure (not shown) has been withdrawn to some extended position, and that the lock is engaged (in this example by being moved downward), which translates the flexure as previously described. Engaging the lock compresses the spring 502 to compress. In FIG. 5C, the lock has been dis-engaged, thereby causing the spring 502 to move back to its non-compressed position and pull the flexure back to its original position.

The above-described subject matter provides significant advantages. The described flexure lock linkage is user removable and replaceable. The linkage may be formed or metal, plastic, or other such flexible material. It is supported along its length within the curved travel pathway, thus preventing it from buckling (despite its flexibility). Upon actuation of the locking button, the flexure moves within the travel pathway until it engages a lock member on the housing.

Having described our invention, what we now claim is set forth below.

1. A tape measure, comprising:
a housing having an outlet;
a reel assembly that carries a tape configured to be extended from the outlet;
a locking mechanism having a first element configured to be moved from a first position, to a second position, and a second element carried by the housing and located near the outlet;
a pathway configured in the housing along at least a curved portion of the reel assembly; and
a flexure configured to be received and retained in the pathway, the flexure having a first end configured to be captured and secured to the first element of the locking mechanism, and a second end configured to capture the second element when the first element of the locking mechanism is moved from the first position to the second position;
wherein capture of the selected element locks the tape measure against movement.

2. The tape measure as described in claim 1, wherein the flexure is formed of a flexible material.

3. The tape measure as described in claim 2, wherein the flexible material is one of: a flexible metal, and a flexible plastic.

4. The tape measure as described in claim 1, wherein the flexure translates motion of the first element of the locking mechanism into translational force along the at least curved position of the reel assembly, together with a linear portion of the pathway that terminates adjacent the outlet.

5. The tape measure as described in claim 1, wherein the flexure is detachable from the first element of the locking mechanism for removal from the housing along the pathway.

6. The tape measure as described in claim 1, further including a spring responsive to movement of the first element from the second position to the first position to restore the flexure to an initial state.

7. A flexure configured for use in association with a tape measure, the tape measure comprising a housing an outlet, a reel assembly that carries a tape configured to be extended from the outlet, a locking mechanism having a first element configured to be moved from a first position, to a second position, and a second element carried by the housing and located near the outlet, and a pathway configured in the housing along at least a curved portion of the reel assembly;
comprising:
a first end; and a second end;
wherein the first end is configured to be captured and secured to the first element of the locking mechanism, and wherein the second end is configured to capture the second element when the first element of the locking mechanism is moved from the first position to the second position.

8. The flexure as described in claim 7, formed of a flexible material.

9. The flexure as described in claim 8, wherein the flexible material is one of: a flexible metal, and a flexible plastic.
